(19) United States
(12) Patent Application Publication
(10) Pub. No.: US 2006/0273555 A1
(43) Pub. Date: Dec. 7, 2006

(54) FOLDABLE TRAILER ADAPTED TO BE CONNECTED TO A BICYCLE

(76) Inventors: Thomas Ahern Morgan JR., Simi Valley, CA (US); Cheng-Nan Lin, Taichung Hsien (TW)

Correspondence Address: HARNESS, DICKEY & PIERCE, P.L.C., P.O. BOX 8910, RESTON, VA, 20195, US

(21) Appl. No.: 11/141,061

(22) Filed: Jun. 1, 2005

(51) Int. Cl. B62B 5/00

(52) U.S. Cl. 280/656

(57) ABSTRACT

A foldable trailer includes a base frame, a canopy frame having a pivot end pivotally connected to a front end of the base frame, a power end rearwardly and upwardly opposite to the pivot end portion, and a weight portion interposed between the power and pivot ends and having a weight area. A biasing member includes a pivoted end pivotally mounted to the base frame, and a connected end connected to the weight area, and is compressible towards the base frame when the weight area is turned by a weight force that is generated by applying a power force to depress the power end downwards. The weight area is located such that a force component imparted by the weight force is greater than, equal to, and smaller than a biasing force of the biasing member when the power end is in an unfolded position, a critical position, and a folded position, respectively.

### BACKGROUND OF THE INVENTION

1. Field of the Invention

This invention relates to a foldable trailer, more particularly to a foldable trailer adapted to be connected to a bicycle.

2. Description of the Related Art

Trailers are generally used with bicycles for carrying small children or for transporting article. FIGS. 1 to 3 show a folding trailer which is disclosed in U.S. Pat. No. 5,474,316, and which includes a U-shaped lower frame 1, an upper frame 2 pivotally mounted on the lower frame 1 at two front ends 201 thereof, and a pair of U-shaped clips 3. Folding frames 102, 202 are pivotally attached to rear ends of the lower frame land the upper frame 2, respectively, to maintain the upper frame 1 at a predetermined distance from the lower frame 1 when extended in an unfolded position. Pivotal jaws 103 are pivotally mounted on the folding frames 202 such that the folding frames 102, 202 are foldable from an extended position to a collapsed position. Each of the clips 3 is fitted around the folding frame 202, and is held by a releasable pin 302 so as to retain the folding frames 102, 202 in the extended position. However, it is necessary to remove the clips 3 before turning the folding frames 102, 202 for folding the trailer, which is inconvenient. Besides, no means is provided to hold the upper frame 2 in place after folding.

U.S. Pat. No. 5,577,746 discloses a folding transport vehicle which may be folded into a compact position by collapsing folding frame units. However, no means is provided to hold the folding frame units firmly in position.

### SUMMARY OF THE INVENTION

The object of the present invention is to provide a foldable trailer which is foldable and unfoldable conveniently, and which can be held firmly in a folded position.

According to this invention, the foldable trailer includes a base frame including front and rear ends opposite to each other in a longitudinal direction, and a middle mount which is interposed between the front and rear ends, and which has a wheel axle that extends in a transverse direction relative to the longitudinal direction and that is provided with a wheel body. A canopy frame includes a pivot end pivotally connected to the front end about a front axis in the transverse direction, a power end which is rearwardly and upwardly opposite to the pivot end and which is disposed upwardly of the rear end, and a weight portion interposed between the pivot and power ends and having a weight area. The power end is turnable relative to the base frame about the front axis among an unfolded position, where the power end is remote from the rear end, a folded position, where the power end is close to the rear end, and a critical position between the unfolded and folded positions. A biasing member provides a biasing force, and includes a pivoted end pivotally mounted to the middle mount about a rear axis, and a connected end connected to the weight area. The biasing member is compressible towards the middle mount in a radial direction when the weight area is brought to turn about the rear axis by a weight force that is generated by applying a power force to depress the power end downwards. The weight area is located such that a force component in the radial direction imparted by the weight force is greater than, equal to, and smaller than the biasing force of the biasing member when the power end is in the unfolded position, the critical position, and the folded position, respectively.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional folding trailer;

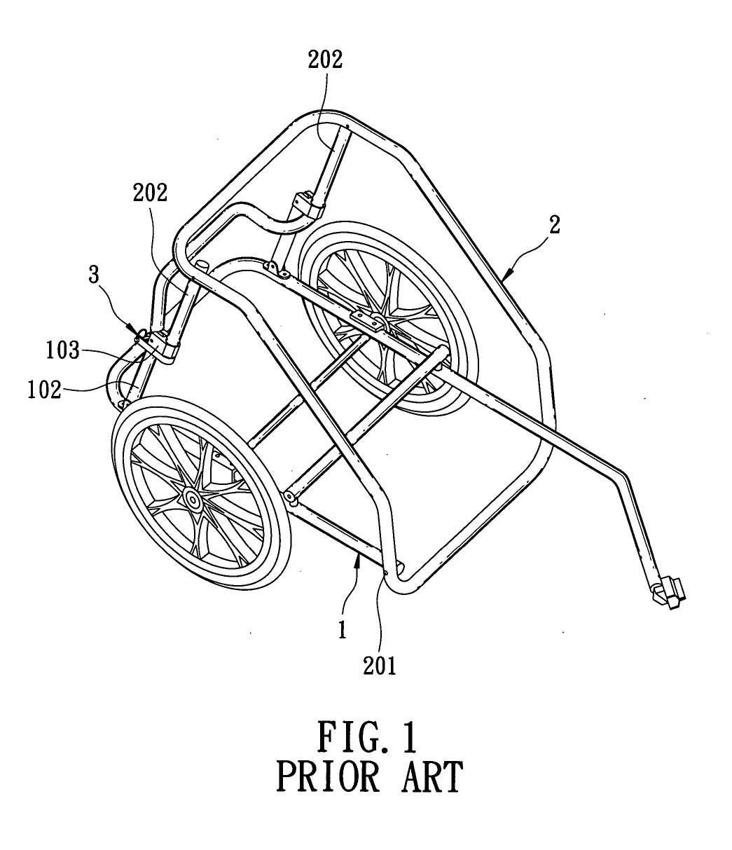

FIG. 2 is a fragmentary perspective view of a pivot portion of a frame unit of the conventional folding trailer;

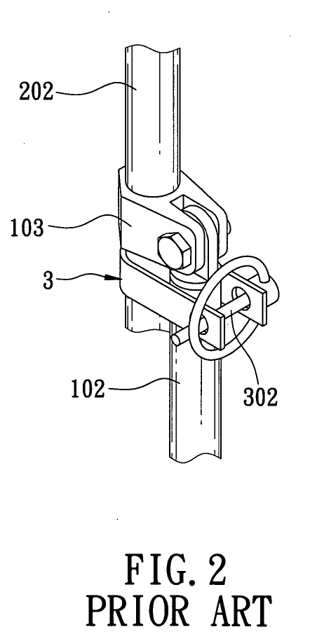

FIG. 3 is a schematic side view of the conventional folding trailer in a folded position;

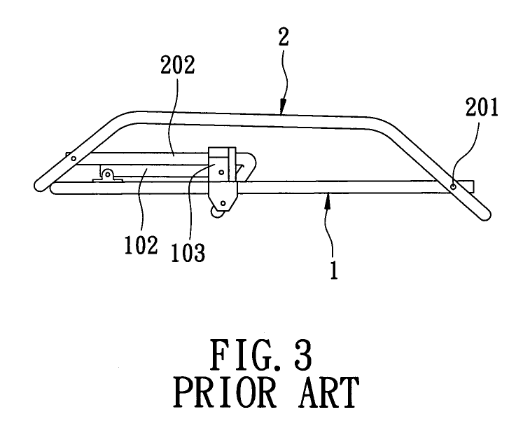

FIG. 4 is a schematic view of the preferred embodiment of a foldable trailer according to this invention;

FIG. 5 is a schematic top view of the preferred embodiment;

FIG. 6 is a schematic rear view of the preferred embodiment;

FIG. 7 is a schematic side view of the preferred embodiment in a folded position; and

FIG. 8 is a schematic view showing that a canopy frame is turned relative to a base frame of the preferred embodiment between an unfolded position and a folded position.

### DETAILED DESCRIPTION OF THE PREFERRED EMBODIMENT

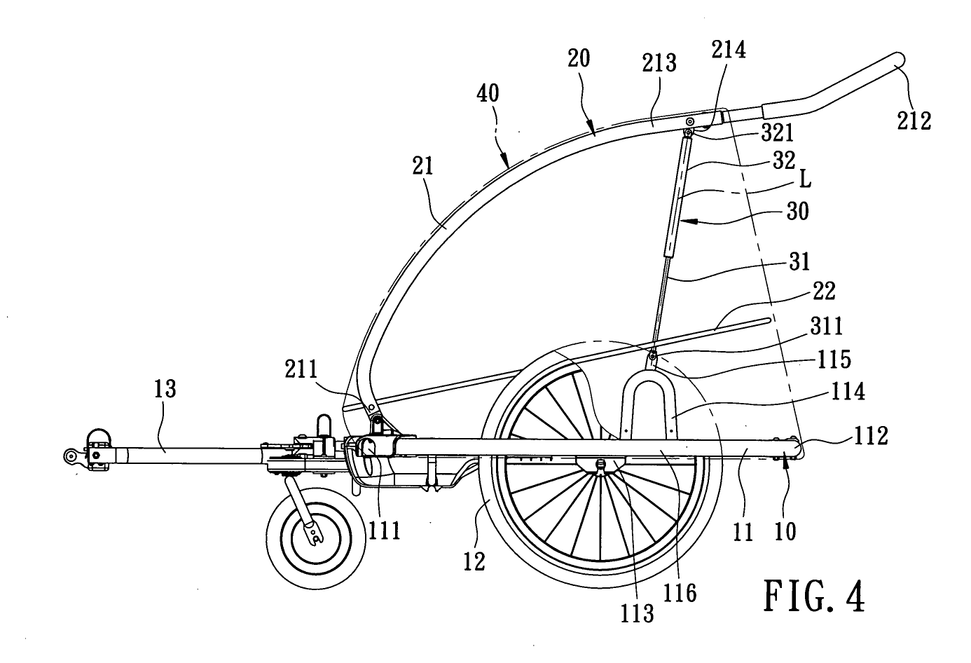

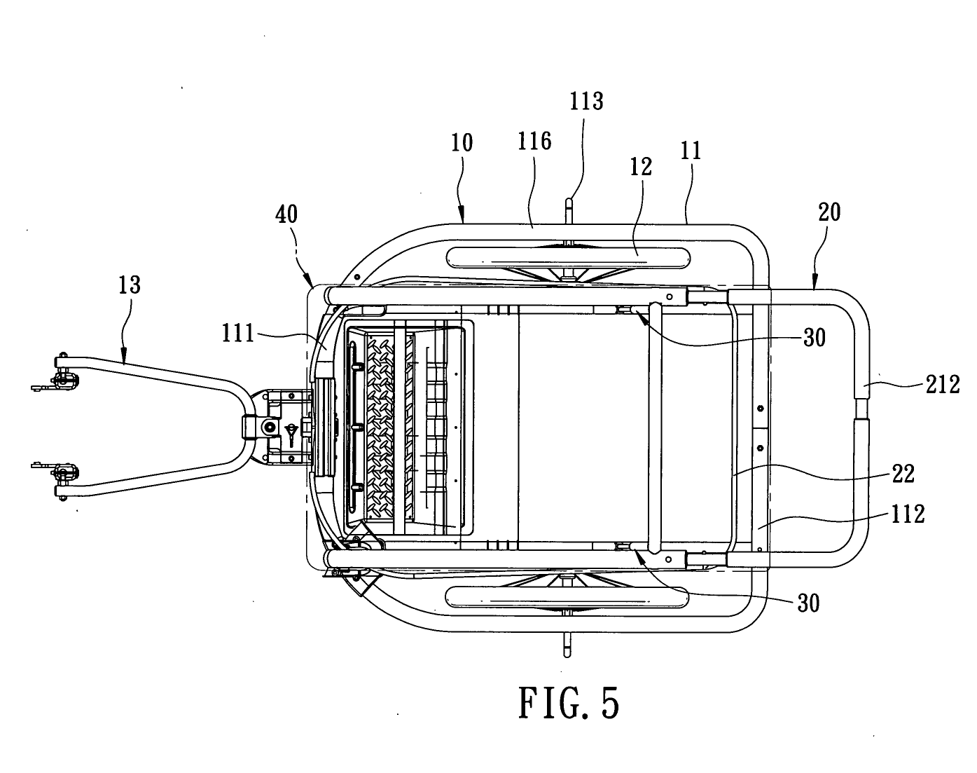

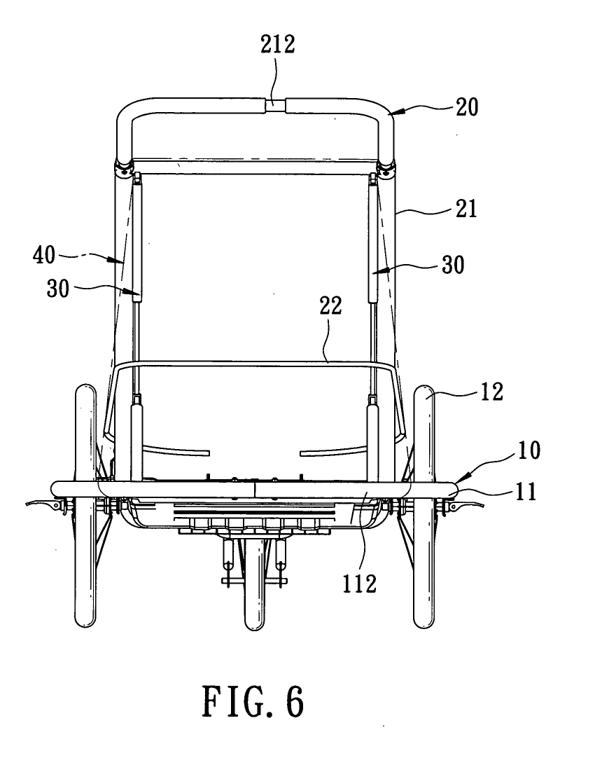

Referring to FIGS. 4 to 6, the preferred embodiment of a foldable trailer according to the present invention is shown to comprise a base frame 10, a canopy frame 20, two biasing members 30, and a canopy 40.

The base frame 10 includes a frame body 11 which has front and rear ends 111, 112 opposite to each other in a longitudinal direction, and a pair of middle mounts which are interposed between the front and rear ends 111, 112. Each of the middle mounts has a rail 116 disposed to integrally interconnect the front and rear ends 111, 112, a wheel axle 113 which extends in a transverse direction relative to the longitudinal direction and which is provided with a wheel body 12, and a supporting post 114 which extends upwardly from the rail 116 and which terminates at a pivot portion 115. A connecting arm 13 extends forwardly from the front end 111 of the base frame 10 forwardly in the longitudinal direction, and is adapted to couple with a bicycle (not shown) in a known manner.

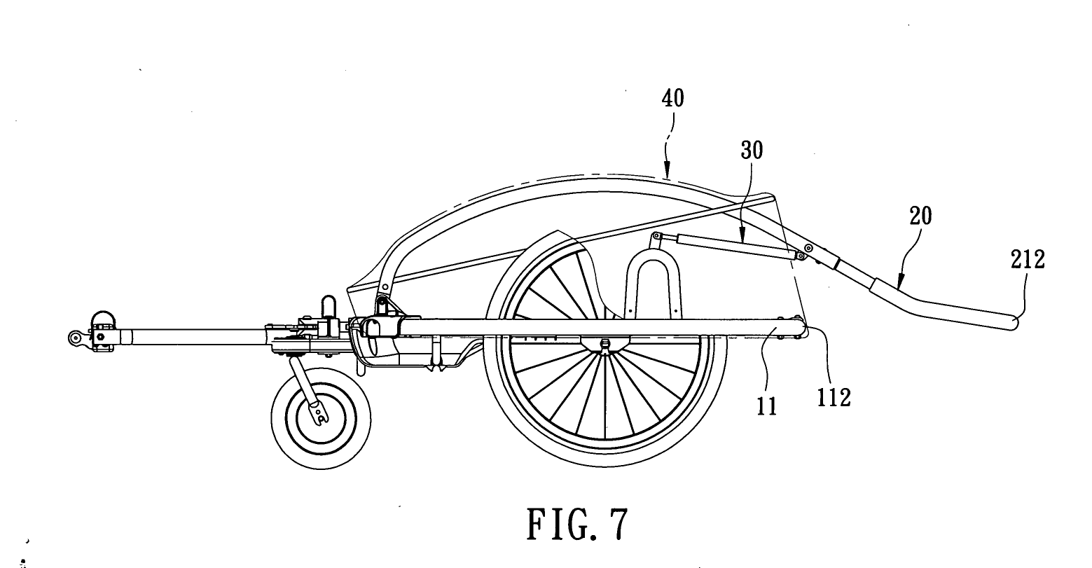

The canopy frame 20 includes a U-shaped main frame 21 and a supporting frame 22. The U-shaped main frame 21 has a pair of pivot ends 211 pivotally connected to the front end 111 about a front axis in the transverse direction, a power end 212 which is rearwardly and upwardly opposite to the pivot ends 211 and which is disposed upwardly of the rear end 112, and a pair of weight portions 213, each of which is interposed between the respective pivot end 211 and the respective power end 212 and each of which has a weight area 214. The power end 212 is turnable relative to the base frame 10 about the front axis among an unfolded position, as shown in FIG. 4, where the power end 212 is remote from the rear end 112, a folded position, as shown in FIG. 7, where the power end 212 is close to the rear end 112, and a critical position between the unfolded and folded positions. The supporting frame 22 is of U-shape, and is pivotally mounted on the pivot ends 211.

Each of the biasing members 30 includes a shank 31, a support body 32, and a biasing unit. In this embodiment, the support body 32 is in the form of a cylinder which defines an air chamber therein and which has a connected end 321 connected to the weight area 214. The biasing unit is air in the air chamber. The shank 31 is in the form of a piston rod which has a pivoted end 311 pivotally mounted to the pivot portion 115 of the respective middle mount about a rear axis and which extends into the air chamber and which is movable relative to the air chamber along an extending axis (L) in a radial direction to correspond to turning of the weight area 214 about the rear axis. Thus, when the piston rod is moved toward the connected end 321 of the cylinder, the air in the air chamber is compressed to provide a biasing force so as to bias the pivoted end 311 away from the connected end 321.

The canopy 40 is disposed to cover the canopy frame 20 and the base frame 10 such that when the power end 212 is moved from the folded position to the unfolded position, the canopy 40 is converted from a collapsed state to an extended state by means of the supporting frame 22.

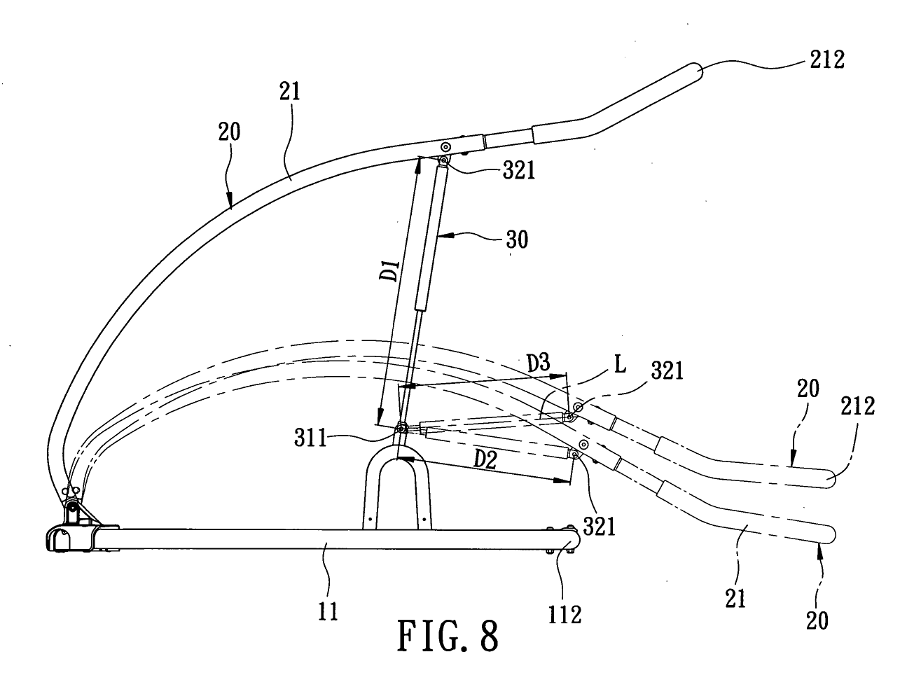

Thus, when a weight force is generated by applying a power force to depress the power end 212 downwards, the weight areas 214 are brought to turn about the rear axis. With reference to FIG. 8, the weight areas 214 are located such that, when the power end 212 is in the unfolded position, the pivoted ends 311 are distant from the connected ends 321 by a maximum length (D1), and a force component along the extending axis (L) imparted by the weight force is greater than the biasing force of the biasing members 30, such that, when the power end 212 is in the critical position, the pivoted ends 311 are distant from the connected ends 321 by a minimum length (D3), and the force component along the extending axis (L) is equal to the biasing force of the biasing members 30, and such that, when the power end 212 is in the folded position, the pivoted ends 311 are distant from the connected ends 321 by a middle length (D2) which is smaller than the maximum length (D1) and which is greater than the minimum length (D3), and the force component along the extending axis (L) is smaller than the biasing force of the biasing members 30. Therefore, when it is desired to fold the trailer of this invention, the power end 212 is depressed to turn the weight areas 214 about the rear axis such that the connected ends 321 are moved towards the pivoted ends 311 to compress the air in the air chamber so as to increase the air pressure in the air chamber until the power end 212 is in the critical position. The power end 212 is further depressed to the folded position such that the biasing force is greater than the force component so as to move the connected ends 321 away from the pivoted ends 311 to thereby hold the canopy frame 20 firmly in the folded position by the biasing force.

When the trailer is to be unfolded, the power end 212 is pulled upward to overcome the biasing force of the biasing members 30 until the power end 212 is in the critical position. Further pulling of the power end 212 results in an increase in the distance between the connected ends 321 and the pivoted ends 311 so that the power end 212 is moved to the unfolded position. Thus, the folding and unfolding operations of the trailer of this invention are convenient to conduct.

It is noted that the pivot portions 115 may be disposed on the rails 116 without the provision of the supporting posts 114. Moreover, the pivoted ends 311 may be disposed to be slightly slidable relative to the rails 116 along with the turning of the power end 212, and may be retained at a predetermined point when the power end 212 is being turned to the critical or folded position.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A foldable trailer comprising:
a base frame including front and rear ends opposite to each other in a longitudinal direction, and a middle mount which is interposed between said front and rear ends, and which has a wheel axle that extends in a transverse direction relative to the longitudinal direction and that is provided with a wheel body;
a canopy frame including a pivot end pivotally connected to said front end about a front axis in the transverse direction, a power end which is rearwardly and upwardly opposite to said pivot end and which is disposed upwardly of said rear end, and a weight portion interposed between said pivot and power ends and having a weight area, said power end being turnable relative to said base frame about the front axis among an unfolded position where said power end is remote from said rear end, a folded position where said power end is close to said rear end, and a critical position between the unfolded and folded positions; and
a biasing member providing a biasing force, said biasing member including a pivoted end pivotally mounted to said middle mount about a rear axis, and a connected end connected to said weight area, and being compressible towards said middle mount in a radial direction when said weight area is brought to turn about the rear axis by a weight force that is generated by applying a power force to depress said power end downwards, said weight area being located such that a force component in the radial direction imparted by the weight force is greater than, equal to, and smaller than the biasing force of said biasing member when said power end is in the unfolded position, the critical position, and the folded position, respectively.

2. The foldable trailer of claim 1, wherein said biasing member includes a shank and a support body which respectively have pivoted and connected ends that are opposite to each other along an extending axis in the radial direction and that are respectively connected to said middle mount and said weight area, said shank being movable relative to said support body along the extending axis to correspond to turning of said weight area about the rear axis, and a biasing unit which is disposed between said shank and said support body to provide the biasing force so as to bias said pivoted end away from said connected end such that said pivoted end is distant from said connected end by a maximum length, a minimum length, and a middle length smaller than the maximum length and greater than the minimum length when said power end is in the unfolded position, the critical position, and the folded position, respectively.

3. The foldable trailer of claim 2, wherein said support body is in form of a cylinder which defines an air chamber therein, said biasing unit being air in said air chamber, said shank being in form of a piston rod which extends into and which is movable relative to said air chamber such that when said piston rod is moved toward said connected end of said cylinder, the air in said air chamber is compressed to provide the biasing force.

4. The foldable trailer of claim 1, further comprising a canopy which is disposed to cover said canopy frame and said base frame such that when said power end is moved from the folded position to the unfolded position, said canopy is converted from a collapsed state to a spread state.

5. The foldable trailer of claim 1, wherein said middle mount has a rail disposed to interconnect said front and rear ends, and a supporting post which extends upwardly from said rail and which terminates at a pivot portion, said pivoted end of said biasing member is pivotally mounted on said pivot portion.

6. The foldable trailer of claim 1, further comprising a connecting arm which extends from said front end of said base frame forwardly in the longitudinal direction and which is adapted to couple with a bicycle.
